(19) United States
(12) Patent Application Publication
(10) Pub. No.: US 2015/0299226 A1
(43) Pub. Date: Oct. 22, 2015

(54) TUNABLE METAL-ORGANIC FRAMEWORKS

(71) Applicant: New Mexico Highlands University, Las Vegas, NM (US)

(72) Inventors: Qiang Wei, Rio Rancho, NM (US); Tatiana Vladimirovna Timofeeva, Las Vegas, NM (US); Carlos Rafael Ordonez Chavez, Las Vegas, NM (US)

(73) Assignee: New Mexico Highlands University

(21) Appl. No.: 14/684,614

(22) Filed: Apr. 13, 2015

Related U.S. Application Data
(60) Provisional application No. 61/980,227, filed on Apr. 16, 2014.

(51) Int. Cl. C07F 3/06

(52) U.S. Cl. CPC C07F 3/06

(57) ABSTRACT

A method, system, and apparatus for tunable metal-organic frameworks comprises a plurality of metallic ions, a plurality of organic linking anions that connect adjacent metallic ions of the plurality of metallic ions, and a plurality of cations connected to the plurality of organic linking anions, wherein the plurality of cations are selected from the group consisting of inorganic cations, organic cations, imidazolium based cations, pyridinium based cations, and cationic organic polymers and coordinated ligands.

### CROSS REFERENCE TO RELATED PATENT APPLICATIONS

This patent application claims the priority and benefit of U.S. provisional patent application 61/980,227, entitled “Tunable Metal-Organic Frameworks”, filed on Apr. 16, 2014. This patent application therefore claims priority to U.S. Provisional Patent Application Ser. No. 61/980,227, which is incorporated herein by reference in its entirety.

### FIELD OF THE INVENTION

Embodiments generally relate to metal-organic frameworks and methods of producing such. Embodiments further relate to metal-organic frameworks with luminescent functionality.

### BACKGROUND

Metal-Organic Frameworks (MOFs) are class of crystalline porous materials generally consisting of metal ions and clusters linked together by organic units. MOFs have emerged as an important new class of porous materials because of their potential for use in a variety of applications, such as drug delivery, gas storage, and chemical separation. MOFs can also have luminescent properties due to the multifaceted nature of their structure. Such luminescent MOFs are of special interest as they may be used in various applications, such as light-emitting display devices and chemical or biological sensing and detection.

Synthesizing and controlling the functionality of highly structurally engineered materials is a target for both the industrial applications and academic research. During the past two decades, scientists have synthesized thousands of MOFs with highly accessible porous structures in an attempt to predict and control the topology of the frameworks and their resultant functionality. MOFs with luminescent functionality have attracted much effort in materials chemistry aimed towards applications in light-emitting and display devices, sensors for environmental or physical stimulations, or biomedical engineering. Accordingly, a need exists for metal-organic frameworks with luminescent functionality.

### SUMMARY

The following summary is provided to facilitate an understanding of some of the innovative features unique to the embodiments disclosed and is not intended to be a full description. A full appreciation of the various aspects of the embodiments can be gained by taking the entire specification, claims, drawings, and abstract as a whole.

It is, therefore, one aspect of the disclosed embodiments to provide a method and system for metal-organic frameworks.

It is another aspect of the disclosed embodiments to provide a method and system for forming metal-organic frameworks.

It is yet another aspect of the disclosed embodiments to provide an enhanced method and system for tunable metal-organic frameworks.

The aforementioned aspects and other objectives and advantages can now be achieved as described herein. A method and system for a metal-organic framework comprises a plurality of metallic ions, a plurality of organic linking anions that connect adjacent metallic ions of the plurality of metallic ions, and a plurality of cations connected to the plurality of organic linking anions, wherein the plurality of cations are selected from the group consisting of inorganic cations, organic cations, imidazolium based cations, pyridinium based cations, and cationic organic polymers and coordinated ligands.

### BRIEF DESCRIPTION OF THE DRAWINGS

The accompanying figures, in which like reference numerals refer to identical or functionally-similar elements throughout the separate views and which are incorporated in and form a part of the specification, further illustrate the embodiments and, together with the detailed description, serve to explain the embodiments disclosed herein.

FIG. 1A depicts a one-dimensional structure of Zn-BTC;

FIG. 1B depicts a packing diagram of chains in MOF {Zn-BTC}{NH₄⁺};

FIG. 2A depicts the [Zn₂(μ-OOC)]₂ dimer with coordinated 6 BTC ligands;

FIG. 2B depicts the double-layer structure of Zn-BTC;

FIG. 2C depicts packing of the double layers viewed along the a axis;

FIG. 3A depicts the crystal structure of {Zn-BTC}{Me₂NH₂⁺};

FIG. 3B depicts the structure of a segment of one chain of {Zn-BTC}{MeNH₂⁺} and axial ligation by BTC ligands from another carboxylate chain;

FIG. 3C depicts a 3D grid viewed along the a axis;

FIG. 4A depicts an example structure of (3,6)-connected Rutile TiO₂;

FIG. 4B depicts an example crystal structure of framework {Zn-BTC}{Me₂NH₂⁺};

FIG. 5A depicts an example structure of Me₂NH₂⁺;

FIG. 5B depicts an example structure of Et₂NH₂⁺;

FIG. 5C depicts an example structure of n-Bu₂NH₂⁺;

FIG. 5D depicts an example structure of Et₃NH⁺;

FIG. 5E depicts an example structure of (PhCH₂)Me₃N⁺;

FIG. 5F depicts an example structure of BMIM;

FIG. 6A depicts an example crystal structure of [Zn₂(μ-OOC)₃];

FIG. 6B depicts an example structure of Zn-BTC anionic framework 605 viewed along the b axis;

FIG. 7A depicts an example structure of single tetrahedral Zn(II) ions and the [Zn(μ-OOC)]₂ dimer;

FIG. 7B depicts an example structure of a Zn-BTC anionic frameworks viewed along a axis;

FIG. 8A depicts an example structure of a Zn₂ dimer and Zn₄ luster coordination environment;

FIG. 8B depicts an example structure of a Zn-BTC anionic framework viewed along a and c axis respectively;

FIG. 9A depicts an example structure of MOF {Zn-BTC-IM} viewed along c axis;

FIG. 9B depicts an example structure of MOF {Zn-BTC-2IM} viewed along c axis;

FIG. 10 depicts a chart of fluorescent emission changes from different dimensional Zn-BTC structures;

FIG. 11 depicts a chart of fluorescent emission changes in iso-reticular Zn-BTC structures with different cations;

FIG. 12 depicts two example crystal structures of a Zn-BTC-BMIM framework;

FIG. 13 depicts an example crystal structure of Zn-BTC-PhCH₂Me₃N framework;

FIG. 14 depicts an example crystal structure of a Zn-BTC-Bu₂NH₂ framework;

FIG. 15 depicts an example crystal structure of a Zn-BTC-Et₃NH framework;

FIG. 16 depicts an example crystal structure of a Zn-BTC-Bu₄N framework; and

FIG. 17 depicts an example of a crystal structure of a Zn-BTC-IM framework.

### DETAILED DESCRIPTION

The particular values and configurations discussed in these non-limiting examples can be varied and are cited merely to illustrate at least one embodiment and are not intended to limit the scope thereof.

The embodiments will now be described more fully hereinafter, in which illustrative embodiments of the invention are shown. The embodiments disclosed herein can be embodied in many different forms and should not be construed as limited to the embodiments set forth herein; rather, these embodiments are provided so that this disclosure will be thorough and complete, and will fully convey the scope of the invention to those skilled in the art. Unnecessary detail of known functions and operations may be omitted from the current description so as not to obscure the present invention. Like numbers refer to like elements throughout. As used herein, the term “and/or” includes any and all combinations of one or more of the associated listed items.

The terminology used herein is for the purpose of describing particular embodiments only and is not intended to be limiting of the invention. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Due to MOFs highly engineerable structure, their luminescent properties can be altered or tuned by including certain cations or coordinated ligands in the frameworks depending on the desired fluorescence for the MOF. Anionic MOFs may be constructed from Zn2+ with 1,3,5-benzenetricarboxylate (BTC) organic anions to form a porous crystalline structure. In alternate embodiments, other metal ions, for example, alkali metals such as Na+, Alkaline metals such as Mg2+, transition metals such as Mn₂⁺, Cd₂⁺, Cr₃ etc., Lanthanides such as Ce₄⁺, and Actinides such as Cm₄⁺, can partially replace the Zn in the frameworks by different doping methods.

Introduction of cations or coordinated ligands to the MOF structure change the anionic Zn-BTC connections in the frameworks and, in turn, the fluorescence of the corresponding MOFs. Cations that can be included in the frameworks, either alone or in various combinations, include the inorganic cations, such as NH₄⁺, Li+ etc., organic cations, such as organic ammonium MeNH₃⁺, Me₂NH₂⁺, Et₃NH⁺, n-Bu₄N⁺, imidazolium or pyridinium based cations such as 1-Butyl-3-methylimidazolium (BMIM) etc., or even cationic organic polymers, such as polyaniline emeraldine salt, polyquaterniums, polypyrrole salt, etc. Coordinated ligands that may be included in the frameworks can include imidazoles. The resulting frameworks have the general structure {Zn-BTC}{Cations}.

Introduction of the cations can be achieved via cation-exchange or from the reaction with the mixed-cation starting reactants. Frameworks 1400 including the NH₄⁺, MeNH₃⁺, Me₂NH₂⁺, Et₂NH₂⁺, and/or n-Bu₂NH₂⁺ cations, such as that depicted in FIG. 14, can be formed by formamide decomposition. The process begins by combining Zn(NO₃)₂.6H₂O, 1,3,5-benzenetricarboxylic acid, and a formamide and then heat treating the solution. Ethanol may be used as a second solvent in addition to the formamide. The formamide can be one of, or a combination of: Formamide, N-Methylformamide, Dimethylformamide, Diethylformamide, or N,N-Dibutylformamide. The heat treatment can be performed at approximately 150° C. for seventy-two hours. A cooling period of approximately twelve hours can also be employed to allow for greater crystal growth. The crystals may then be washed with a solvent, such as the corresponding formamide, and sonicated to remove any remaining un-reacted starting materials. Washing and sonication can be performed multiple times to increase the purity of the frameworks.

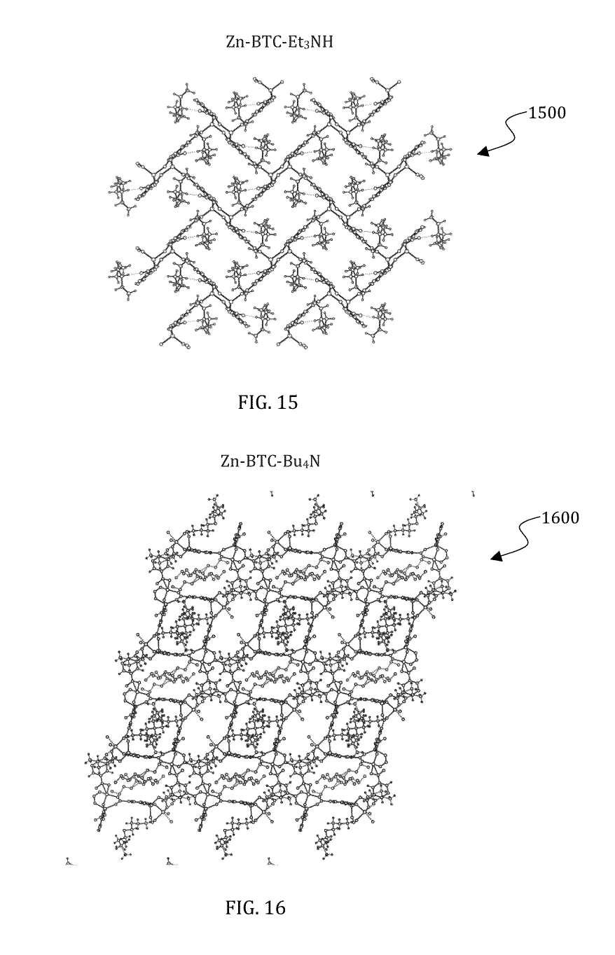

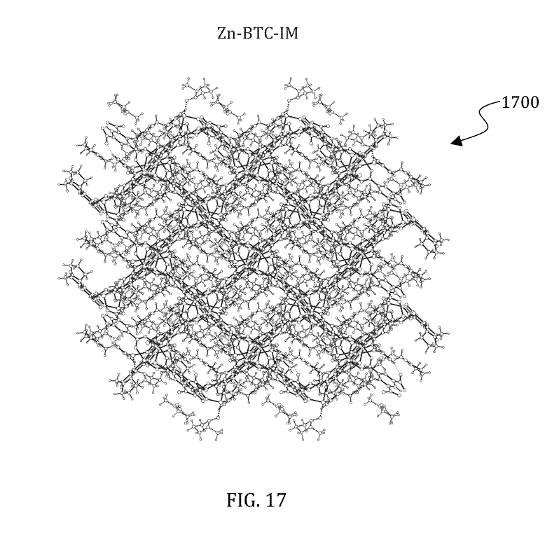

Frameworks including n-Bu₂NH₂⁺, Et₃NH⁺, and/or Imidazole cations, such as framework 1400 depicted in FIG. 14, framework 1500 depicted in FIG. 15, and framework 1700 depicted in FIG. 17, can be formed by addition of an amine base, such as Dibutylamine, Triethylammine or Imidazole. The process begins by combining Zn(NO3)2.6H2O, 1,3,5-benzenetricarboxylic acid, an amine base and either ethanol or N-Methyl-2-pyrrolidone (NMP). The solution can then be heat treated at approximately 150° C. for seventy-two hours. A cooling period of approximately twelve hours can also be employed to allow for greater crystal growth. The crystals may then be washed with a solvent, such as NMP or ethanol, and sonicated to remove any remaining un-reacted starting materials. Washing and sonication can be performed multiple times to increase the purity of the frameworks.

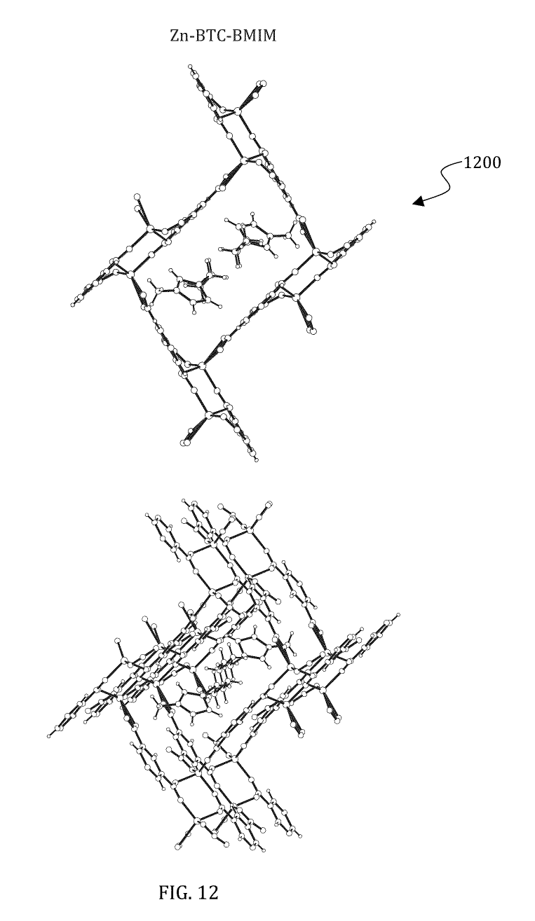

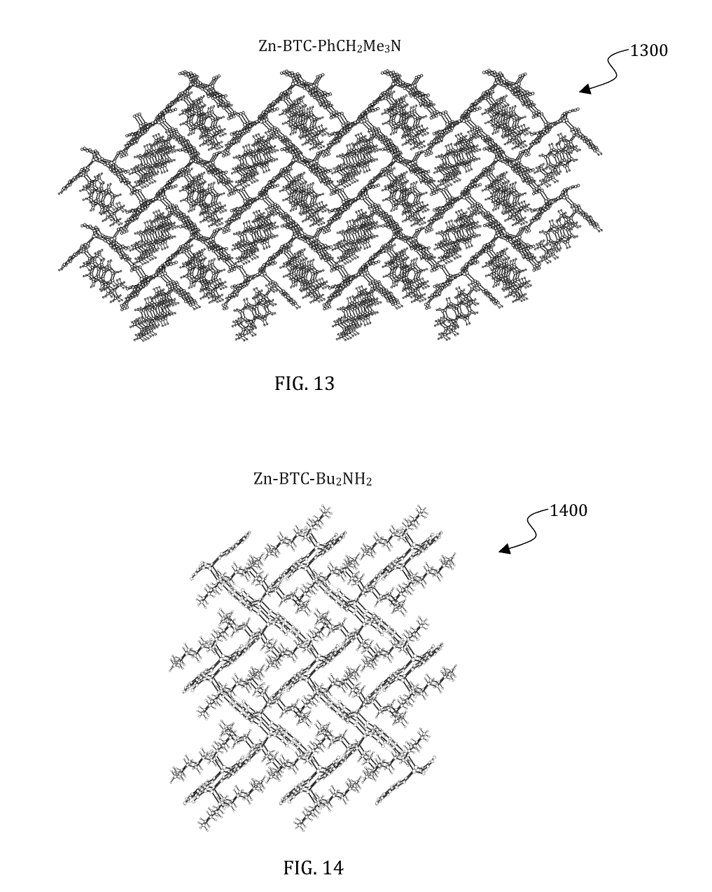

Frameworks including Me₄N⁺, n-Bu₄N⁺, (PhCH₂)Me₃N⁺, BMIM, and/or Imidazole cations, such as framework 1200 depicted in FIG. 12, framework 1300 depicted in FIG. 13, and framework 1600 depicted in FIG. 16, can be formed by direct addition of the cation. The process begins by combining Zn(NO3)2.6H2O, 1,3,5-benzenetricarboxylic acid, an immonium salt or imidazole, and either ethanol or NMP. The ammonium salt may be one of: Tetramethyl-ammonium hydroxide pentahydrate, Tetrabutyl-ammonium nitrate or Benzyltrimethyl-ammonium Chloride. Addition of BMIM cations can be achieved by using 1-Butyl-3-Methyl-imidazolium Tetrafluoro-borate in place of an ammonium salt. The solution can then be heat treated at approximately 150° C. for at least seventy-two hours. A cooling period of approximately twelve hours can also be employed to allow for greater crystal growth. The crystals may then be washed with NMP or ethanol and sonicated to remove any remaining un-reacted starting materials. Washing and sonication can be performed multiple times to increase the purity of the frameworks.

In alternate embodiments, ligands with three carboxylate groups can also be utilized to form similar structures, such as the alkyl or halogen atoms substituted BTC ligands, and 1,3,5-cyclohexane tricarboxylic acid, etc.

Anionic MOFs with cations residing in the voids of the frameworks are relatively rare. The reaction of divalent metal ions, such as Zn²⁺, with trivalent anions, such as 1,3,5-benzenetricarboxylate (BTC), can be used to form anionic frameworks where counter cations reside in the void spaces. For example, Zn(NO₃)₂.6H₂O salt and the neutral H₃BTC ligand can be dissolved in organic solvents. The system is then heated with corresponding cations under solvothermal conditions to form crystals.

Three methods can be used to introduce the cations needed in the frameworks. One method includes in situ generation of cations from the decomposition of formamides. For example, NH₄⁺, MeNH₃⁺, and Me₂NH₂⁺ can be generated from formamide, N-methylformamide, and N,N-dimethylformamide, respectively. Another method requires amine bases to generate corresponding organic ammonium cations, for example, in the case of Et₃NH⁺ and n-Bu₂NH₂⁺ cations. In the third alternative method cations, such as quaternary ammonium n-Bu₄N⁺ and Me₄N⁺ are directly added in the reaction.

When applying the first method to introduce the cations, the corresponding formamides could be utilized directly as solvents. However, when using the second or third methods to introduce the cations, NMP or a mixture of NMP with EtOH are used as the solvents. In some cases, EtOH can be mixed with the formamides in order to generate better quality crystals.

Preferably, the reaction system can be heated at 150 degrees C. for 3 days and allowed to cool to room temperature naturally in the oven. Longer reaction time in method 3 may be required to achieve better crystalline samples if single-crystal X-ray crystallography analysis is desired.

With the exception of imidazole, the MOFs all contain anionic Zn-BTC coordination polymers with cations in their structures. The dimensionality of the anionic Zn-BTC coordination polymer is strongly related with the hydrogen-bond forming ability of the cations used. If the cations have 4H-bonding sites, the anionic Zn-BTC forms a one-dimensional chain structure; if the cations have 3H-bondings, the anionic Zn-BTC forms a two-dimensional layer structure; and when the cations have 2 or less H-bonding sites, a three-dimensional framework of Zn-BTC is formed.

When cations have more H-bonding sites, fewer accessible carboxylate groups of BTC are involved in the coordination with Zn(II) ions. Therefore, the higher H-bonding results in lower dimensional structures.

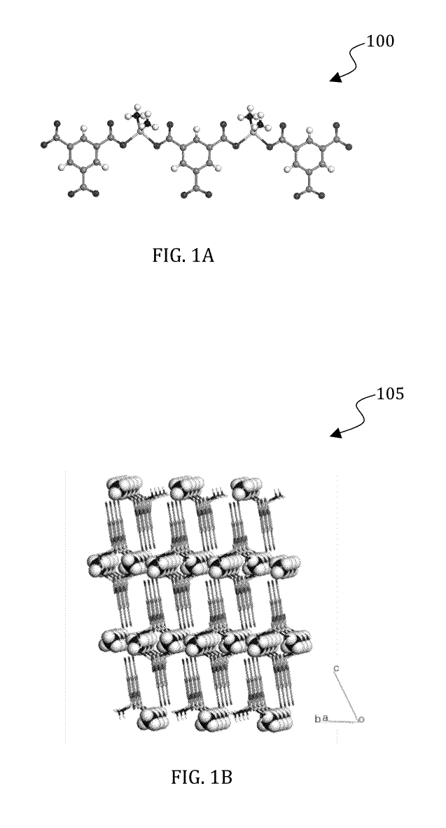

FIG. 1A illustrates the one-dimensional structure of anionic Zn-BTC 100. In the case of MOF {Zn-BTC}{NH4+} 105, BTC ligands are connected through only two carboxylate groups with single zinc ions to form ID chain structures, as shown in FIG. 1B. Each Zn(II) is tetrahedrally coordinated by two carboxylate groups from BTC in a monodentate binding mode and two NH3 molecules. Those chains are packed to form layers and NH₄⁺ cations are located between the layers in the structure.

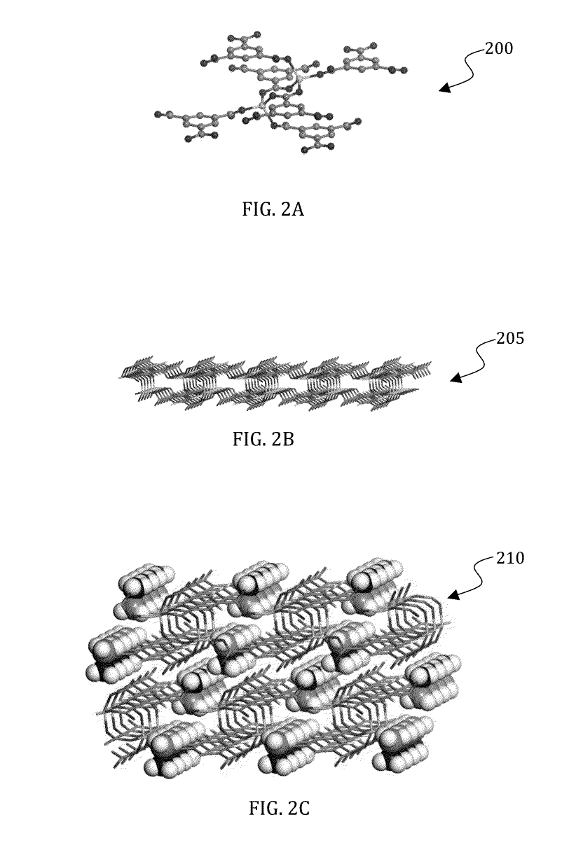

With respect to FIG. 2A unlike MOF {Zn-BTC}{NH₄⁺}, MOF {Zn-BTC}{MeNH₃⁺} 200 contains [Zn₂(μ-OOC)₂] dimers in the frameworks, and those dimers are connected through BTC ligands to form a double-layer anionic framework 205 shown in FIG. 2B. Each [Zn₂(μ-OOC)₂] is surrounded by 6 BTC ligands, which are parallel to each other. Each Zn(II) is still in a tetrahedral coordination with the 4 carboxylate groups of BTC, and each BTC ligand uses one carboxylate group to bridge two Zn atoms to form the [Zn₂(μ-OOC)₂] dimer structure and using the remaining two carboxylate groups to connect the surrounding Zn₂ dimers to form the double-layer structure. The methyl groups of the MeNH₃⁺ cations are located inside the double layers, while the —NH₃ parts are approaching out of the layers to form hydrogen bonds with nearby layers in a closed packing structure 210 shown in FIG. 2C.

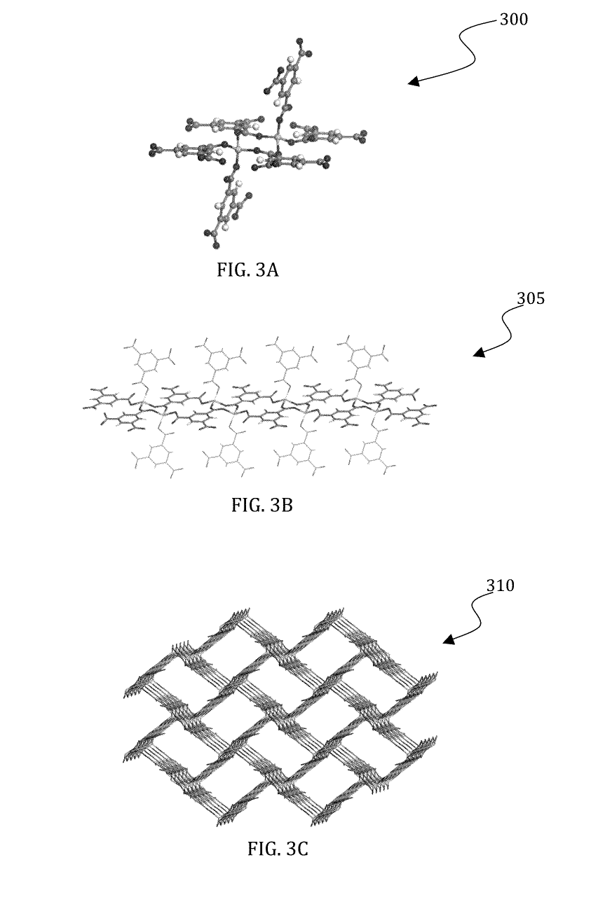

With respect to FIG. 3, the crystal structure of {Zn-BTC}{Me₂NH₂⁺} is shown. In FIG. 3A the coordination environment of the Zn(II) cation and the [Zn₂(μ-OOC)]₂ structural motif 300 is shown. FIG. 3B illustrates a segment of one chain 305, with the chain shown in bold and axial ligation by BTC ligands from another carboxylate chains shown in feint. FIG. 3C depicts a 3D grid viewed 310 along the a axis with hydrogen atoms and guests atoms omitted for clarity.

When cations have 2 or less hydrogen-bond forming abilities, the three-dimensional framework structures of anionic Zn-BTC are formed. The size and shape of the cations influences the three-dimensional framework structures. However, among those three-dimensional frameworks, the most common anionic Zn-BTC structure is in MOF {Zn-BTC}{Me₂NH₂⁺}. In this structure, [Zn₂(μ-OOC)₂] motifs are formed and each motif can be surrounded by 6 BTC ligands. 4 BTC ligands are now located in the same plane, while two of the BTC ligands are located in the near perpendicular planes. Such a connection of [Zn₂(μ-OOC)₂] motifs results in the X-shaped chains cross-linked with each other to form a channeled Zn-BTC anionic framework as shown in FIGS. 3A-3C.

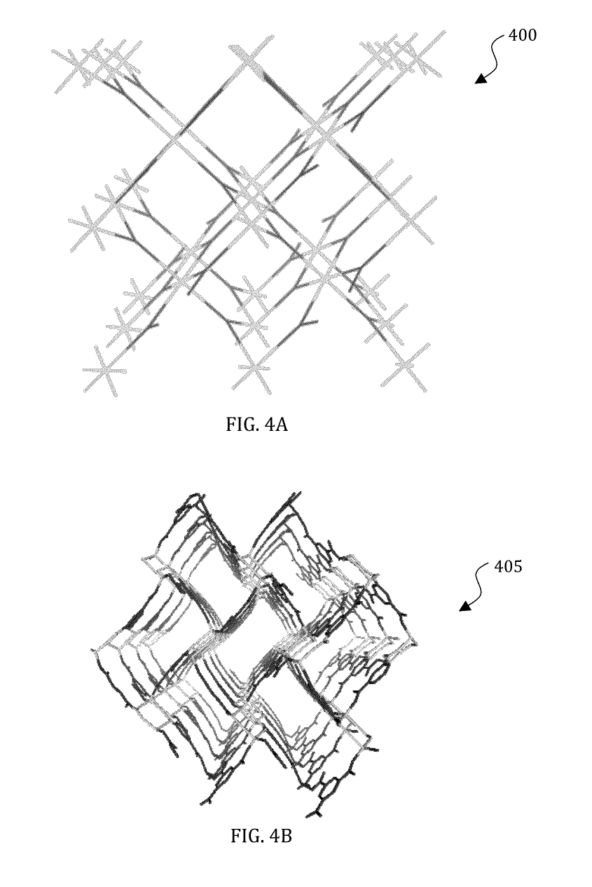

The [Zn₂(μ-OOC)₂] structure motif and BTC can be viewed as second building units (SBUs), the Zn-BTC framework can then be seen as a (3,6)-connected net, i.e., one BTC ligand connects three Zn₂ units and each Zn₂ unit connects six BTC ligands. The Zn-BTC anionic framework in MOF {Zn-BTC}{Me₂NH₂⁺} therefore has the same topology as Rutile, TiO₂. The topologic similarity between TiO₂ and MOF {Zn-BTC}{Me₂NH₂⁺} is shown in FIGS. 4A-B. Specifically, FIG. 4A depicts an example structure of (3,6)-connected Rutile TiO₂ 400 and FIG. 4B depicts an example crystal structure of framework {Zn-BTC}{Me₂NH₂⁺} 405.

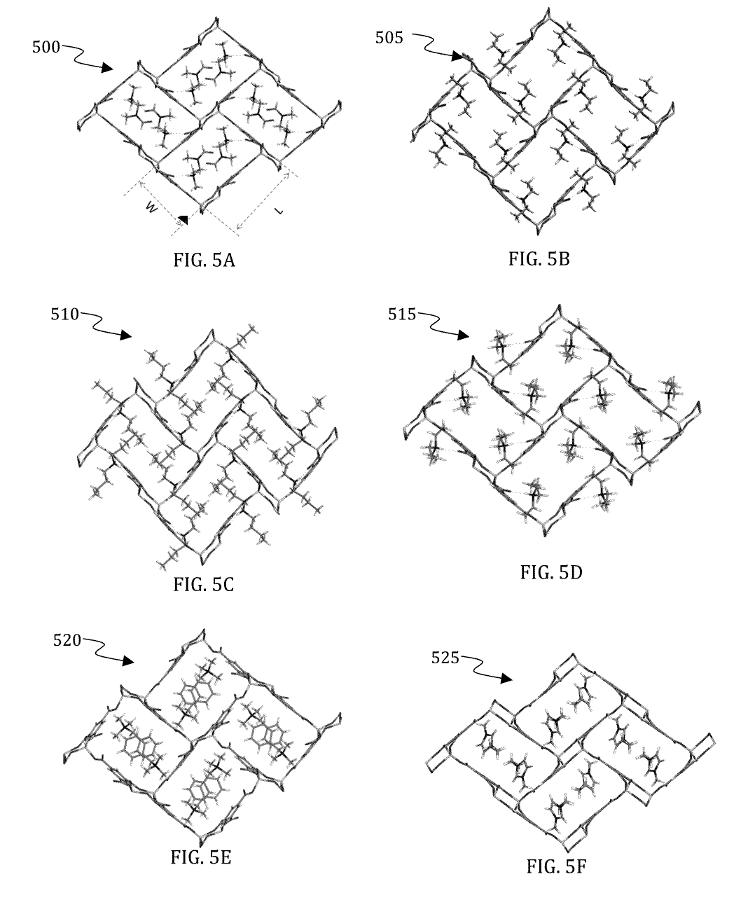

Cations of Et₂NH₂⁺, n-Bu₂NH₂⁺, Et₃NH⁺, (PhCH₂)Me₃N⁺, and BMIM all result in the same anionic Zn-BTC framework as in MOF {Zn-BTC}{Me₂NH₂⁺}. However, differences in the size and shape, as well as in the interactions of cations with frameworks, result in different cation packing in the channels and correspondingly different channels size within the frameworks, as shown in FIGS. 5A-F. FIGS. 5A-F illustrate the cations packing position in the iso-reticular Zn-BTC anionic frameworks viewed along the channels direction. FIG. 5A depicts the structure 500 of Me₂NH₂⁺. FIG. 5B depicts the structure 505 of Et₂NH₂⁺. FIG. 5C depicts the structure 510 of n-Bu₂NH₂⁺. FIG. 50 depicts the structure 515 of Et₃NH⁺. FIG. 5E depicts the structure 520 of (PhCH₂)Me₃N⁺. FIG. 5F depicts the structure 525 of BMIM.

Except electrostatic interactions, additional hydrogen bonding interactions exist between the cations and the anionic Zn-BTC frameworks in MOFs with cations of Me₂NH₂⁺, Et₂NH₂⁺, n-Bu₂NH₂⁺, and Et₃NH⁺. The small size of Me₂NH₂⁺ cations allows DMF solvents to co-exist in the channels as shown in FIG. 5A. The relatively larger size of Et₂NH₂, n-Bu₂NH₂⁺, and Et₃NH⁺ exclude the extra solvent molecules, and permit them to be incorporated into the channels by approaching the linear alkyl groups through the wall of the channels. The linear shape of (PhCH₂)Me₃N⁺ and BMIM cations facilitates their accommodation in the centers of the channels, and in both cases only electrostatic interactions exist between the cations and Zn-BTC anionic frameworks. In the case of (PhCH₂)Me₃N⁺, the closest distance between the centroids of the nearby situated benzene rings of the cations was about 4.5 Å.

The geometry and the template cations' interaction preferences lead to variance in the channel structures in those iso-reticular MOFs (as seen in FIGS. 5A-F). For example, the length of the cross-section of the channels can extend from 10.97 to 12.40 Å in order to adapt cations from smaller Me₂NH₂⁺ to larger n-Bu₂NH₂⁺, and the width also changes from cation to cation. The separation between the nearby cations along the channel direction in those MOFs does not result in significant change.

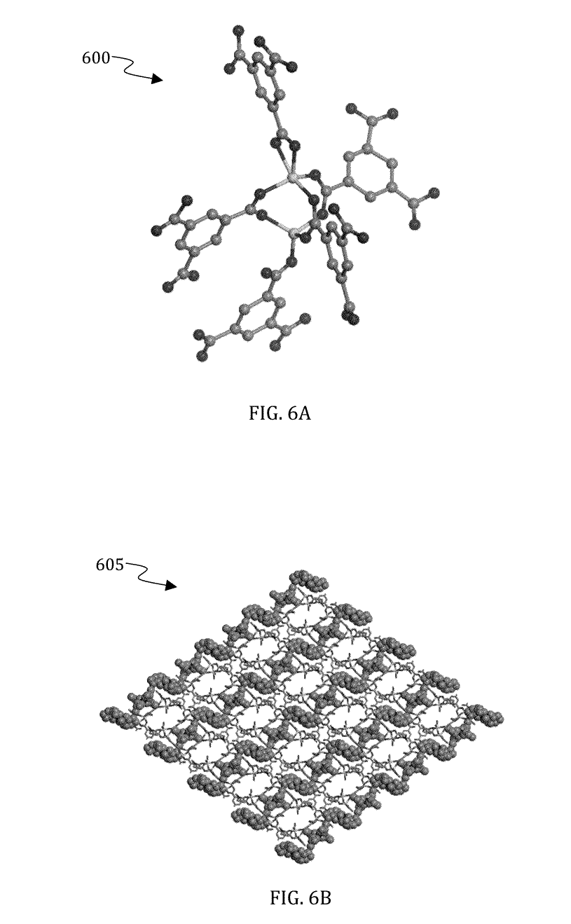

Non-linear quaternary ammonium cations such as n-Bu₄N⁺ and Me₄N⁺ result in two three-dimensional anionic Zn-BTC frameworks. The size of the cations affects the Zn-BTC coordination in the resulting frameworks. The bulky n-Bu₄N⁺ cations force the Zn-BTC frameworks to incorporate them inside the channels on one same layers and leave the other channels on the alternative layers open for solvents, as shown in FIGS. 6A-B. FIGS. 6A-B generally illustrate the crystal structure of {Zn-BTC}{n-Bu₄N⁺}. In FIG. 6A, the crystal structure 600 of [Zn₂(μ-OOC)₃] dimer with coordinated 5 BTC ligands is shown. FIG. 6B depicts cation locations in the Zn-BTC anionic framework 605 viewed along the b axis. In this MOF, {Zn-BTC}{n-Bu₄N⁺}, the Zn₂ dimer is in the [Zn₂(μ-OOC)₃] configuration being surrounded by 5 BTC ligands. The BTC ligand uses the two-carboxylate groups to form the Zn₂ dimers in bridging binding mode, and uses the other carboxylate in monodentate or chelate binding mode to connect the dimers into a channeled framework.

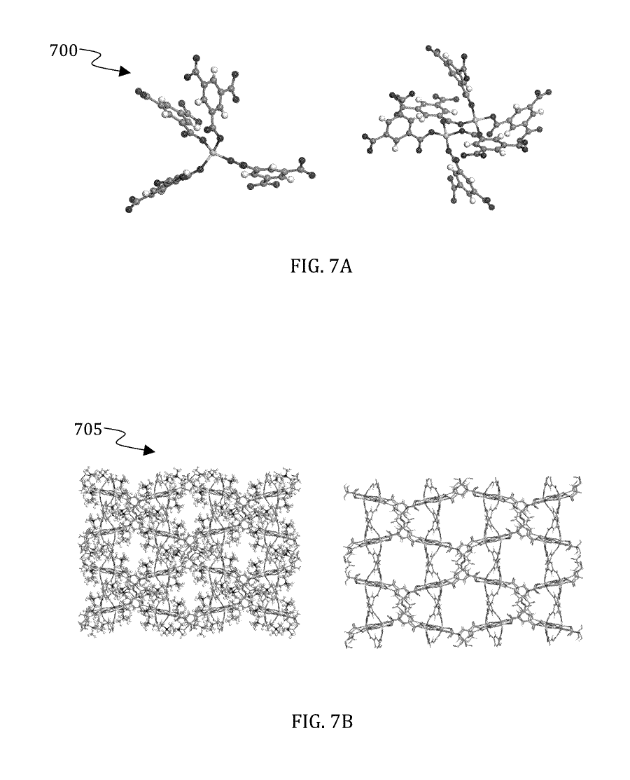

Me₄N⁺ cations, smaller in size than (PhCH₂)Me₃N⁺, generate a Zn-BTC anionic framework that differs from the previously discussed MOF {Zn-BTC}{Me₂NH₂⁺}, as shown in FIGS. 7A-7B. FIGS. 7A-B illustrate the crystal structure of {Zn-BTC}{Me₄N⁺}. In FIG. 7A, the coordination environments 700 of single tetrahedral ZOO ions and the [Zn(μ-OOC)]₂ dimer are shown. In FIG. 7B, Zn-BTC anionic frameworks 705 with and without Me₄N⁺ cations viewed along a axis are shown with NMP solvent molecules omitted for clarity.

In MOF {Zn-BTC}{Me₄N⁺}, two different coordination connectors of the Zn(II) exist. One is the isolated single Zn(II) which is tetrahedrally coordinated by 4 BTC ligands. The other is a [Zn₂(μ-OOC)₂] dimer as seen in the MOF {Zn-BTC}{Me₂NH₂⁺}. The anionic Zn-BTC frameworks can be surrounded by the Me₄N⁺ cations, and NMP solvent molecules can then occupy the remaining void space in the framework.

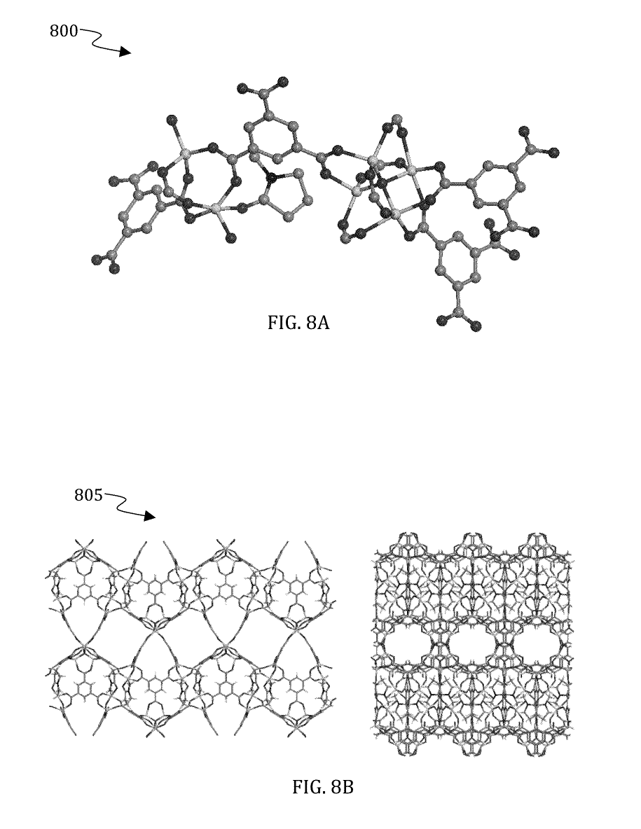

Different methods for introducing the same cation can lead to different final framework structures. For example, when the N,N-dibutylamine is used to form n-Bu₂NH₂⁺ cations, instead of in situ generation of them from decomposition of N,N-dibutylformamide, a crystalline sample, MOF {Zn-BTC}{n-Bu₂NH₂⁺}-M2, can be obtained. The MOF {Zn-BTC}{n-Bu₂NH₂⁺}-M2 contains two different Zn-BTC coordination motifs. One is the [Zn₂(μ-OOC)₃] dimer and another is the [Zn₄(O)(μ-OOC)₇] cluster. The Zn-BTC framework results in alternative cage and channel structures connected between the Zn₂ and Zn₄ clusters by BTC ligands, as illustrated in FIG. 8. Specifically, FIGS. 8A-B illustrate MOF {Zn-BTC}{n-Bu₂NH₂⁺}-M2. In FIG. 8A, the Zn₂ dimer and Zn₄ cluster coordination environment 800 is shown. In FIG. 8B, the packing diagrams of the Zn-BTC anionic framework 805 is shown viewed along a and c axis, respectively. Disordered NMP solvents are omitted for clarity.

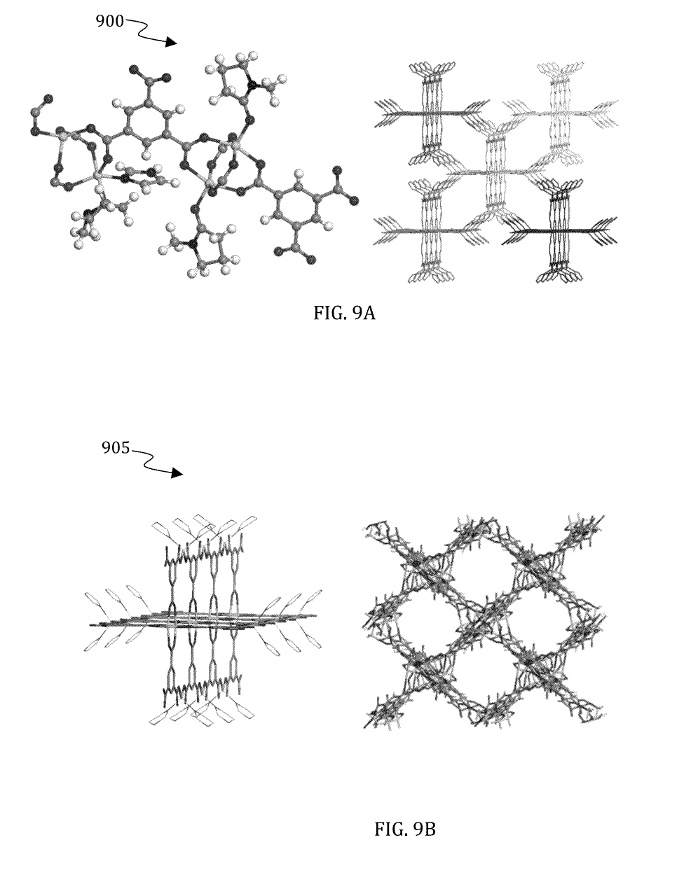

FIG. 9A shows the crystal structure 900 of MOF {Zn-BTC-IM} where the conjunction of two different dimeric units and the three-dimensional Zn-BTC framework structure viewed along c axis. IM and NMP are omitted for clarity. FIG. 9B depicts the crystal structure 905 of MOF {Zn-BTC-2IM} where the fragment of one-dimensional polymeric chain and the hydrogen bonding association between chains viewed along c axis are shown.

Imidazole (IM) cannot be used as a base to generate imidazolium cations in the same Zn-BTC reaction system; the reaction fails. The introduced IM acts as an additional coordination ligand to ZOO ions resulting in only neutral frameworks. Two reaction composites of Zn(II):BTC:IM with molar ratio of 1:1:1 and 1:1:2 result in two different Zn-BTC neutral MOFs, {Zn-BTC-IM} and {Zn-BTC-2IM}, respectively. MOF {Zn-BTC-IM} represents a three-dimensional grid-like framework. It has two types of Zn(II)-BTC connection environments. One is the [Zn₂(μ-OOC)₃] dimer and the other is the paddle-wheel [Zn₂(μ-OOC)₄] dimer 900, shown in FIG. 9A. The Zn(II) ions of the dimers are also coordinated by NMP solvent molecules or IM ligands. However, MOF {Zn-BTC-2IM} has an entirely different structure, where only [Zn₂(μ-OOC)₄] dimers exist, and those dimers are connected with single Zn(II) ions through the BTC ligands to form a one-dimensional chain 905 as shown in FIG. 9B. The single Zn(II) ions are coordinated by two extra IM ligands to form a tetrahedral N₂O₂ set. Each chain can therefore have 8 IM branches approaching out, and the chains are interconnected through the hydrogen bindings between those IM ligands to form a three-dimensional network.

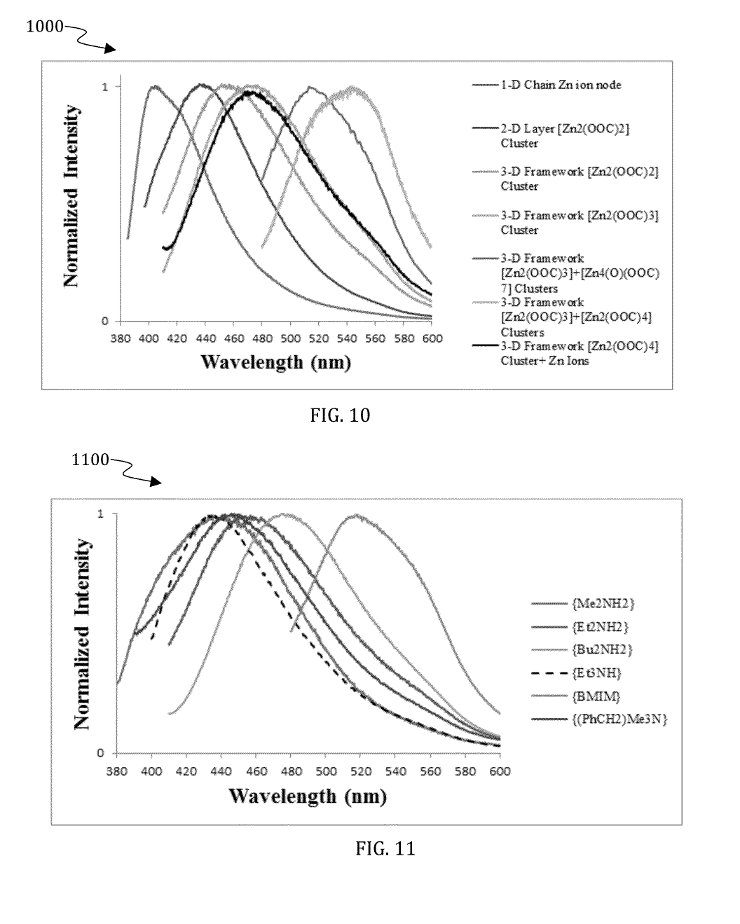

All of the formed Zn-BTC frameworks disclosed herein show fluorescence emission in the visible spectrum at the solid state. The fluorescent spectra of maximum emission of each of, the MOFs are shown in chart 1000 in FIG. 10 and chart 1100 in FIG. 11.

Table 1 illustrates the structural parameters of the channels in the iso-reticular {Zn-BTC}{Cation} MOFs.

TABLE 1

| | Cross-section | | | | Distance of |
|---|---|---|---|---|---|
| | size of the | | | N . . . O | N—N of the |
| | Channels | | Zn—Zn | distance in the | nearby organic |
| | (L × W) (Å) | | distance in the | N—H ^{. . .} O H- | cations along |
| Cation | L | W | [Zn₂(μ-OOC)₂] (Å) | bonding (Å) | the channels (Å) |
| Me₂NH₂⁺ | 10.97 | 7.31 | 3.8529(4) | 2.722(2) | 9.43 |
| Et₂NH₂⁺ | 11.37 | 7.28 | 3.8816(8) | 2.722(3)&2.748(3) | 9.51 |
| n-Bu₂NH₂⁺* | 12.40 | 6.80 | 3.975(2) | 2.753(6)&2.683(6) | 9.49 |
| Et₃NH⁺ | 11.61 | 7.59 | 3.972(5) | 2.724(6) | 9.46 |
| (PhCH₂)Me₃N⁺ | 11.55 | 8.55 | 4.037(1) | / | 9.57 |
| BMIM | 11.60 | 6.95 | 4.1142(9) | / | 9.30 |

Table 2 provides a summary of the cations H-bond forming ability, the corresponding Zn-BTC structure, the Zn coordination motif, and the fluorescent emission wavelength at maximum intensity.

TABLE 2

| | | Number of | Dimensionality | Number of (μ-OOC) | FL Emission |
|---|---|---|---|---|---|
| | | H-bonding | of Zn-BTC | involved in Zn | @ maximum |
| MOF | Cation | sites | Framework | cluster motif | intensity (nm) |
| {Zn-BTC} | NH₄⁺ | 4 | 1D | Zn(II), n = 0 | 405 |
| {NH₄⁺} | | | | | |
| {Zn-BTC} | MeNH₃⁺ | 3 | 2D | [Zn₂(μ-OOC)₂], n = 2 | 440* |
| {MeNH₃⁺} | | | | | |
| {Zn-BTC} | Me₂NH₂⁺ | 2 | 3D | [Zn₂(μ-OOC)₂] | 434 |
| {Me₂NH₂⁺} | | | | | |
| {Zn-BTC} | Et₂NH₂+ | 2 | 3D | [Zn₂(μ-OOC)₂] | 455 |
| {Et₂NH₂⁺} | | | | | |
| {Zn-BTC} | n-Bu₂NH₂⁺ | 2 | 3D | [Zn₂(μ-OOC)₂] | 476 |
| {n-Bu₂NH₂⁺}-M1^{#} | from | | | | |
| | formamide | | | | |
| {Zn-BTC} | Et₃NH⁺ | 1 | 3D | [Zn₂(μ-OOC)₂] | 438 |
| {Et₃NH⁺} | | | | | |
| {Zn-BTC} | (PhCH₂)Me₃N⁺ | 0 | 3D | [Zn₂(μ-OOC)₂] | 445 |
| {(PhCH₂)Me₃N⁺} | | | | | |
| {Zn-BTC} | BMIM | 0 | 3D | [Zn₂(μ-OOC)₂] | 520 |
| {BMIM} | | | | | |
| {Zn-BTC} | Me₄N⁺ | 0 | 3D | [Zn₂(μ-OOC)₂] + Zn(II) | 450 |
| {Me₄N⁺} | | | | | |
| {Zn-BTC} | n-Bu₄N⁺ | 0 | 3D | [Zn₂(μ-OOC₃], n = 3 | 470 |
| {n-Bu₄N⁺} | | | | | |
| {Zn-BTC} | n-Bu₂NH₂⁺ | 2 | 3D | [Zn₂(μ-OOC)₂] + | 515 |
| {n-Bu₂NH₂⁺}-M2^{#} | from | | | [Zn₄(O)(μ-OOC)₇], n = 7 | |
| | amine | | | | |
| {Zn-BTC-IM} | IM as | \ | 3D | [Zn₂(μ-OOC)₃] + | 543 |
| | coordination | | | [Zn₂(μ-OOC)₄], n = 4 | |
| | ligand | | | | |
| {Zn-BTC-2IM} | IM as | \ | 1D | [Zn₂(μ-OOC)₄] + Zn(II) | 470 |
| | coordination | | | | |
| | ligand | | | | |

As organized in Tables 1 and 2 and FIGS. 10 and 11, two points regarding the anionic Zn-BTC structures are important.

When the Zn-BTC anionic structure is changed from one-dimensional chain to a two-dimensional layer, and finally to three-dimensional framework, the emission wavelength shifts from violet (e.g., 405 nm) to blue (e.g., 455 nm), and even to green (e.g., 515 nm), Those changes are related with dimensionality of the crystal structures. More specifically, those changes have a close relationship with what type of Zn-nodes the framework contains. The Zn-nodes existing in the frameworks can include the isolated single Zn(II) ions and the (μ-OOC) bridged Zn(II)-clusters, such as [Zn₂(μ-OOC)₂], [Zn₂(μ-OOC)₃], [Zn₂(μ-OOC)₄], and [Zn₄(O)(μ-OOC)₇]. The emission behavior for those Zn-BTC MOFs is such that when more bridging binding mode carboxylate (μ-OOC) are used to build the Zn-nodes in frameworks, the longer wavelength emission of MOFs can be expected.

For example, in the case of NH₄⁺, only single Zn(II) ions act as connection nodes and the BTC ligands coordinated to the Zn₂ nodes in a monodentate binding mode. The emission from this framework is a violet light (405 nm), which is close to the H₃BTC ligand itself (emission at ˜365 nm). However, when the MeNH⁺ is used, the framework has a two-dimensional layer structure with [Zn₂(μ-OOC)₂] dimers as the connection nodes, and as shown in FIG. 10, the indigo emission at 440 nm is observed. Moreover, this framework releases an emission peak at 370 nm under an excitation wavelength of 340 nm, which can be assigned to the BTC ligand-centered charge transitions. When the cations are changed to less than 2 hydrogen-bond forming cations, such as n-Bu₄NH⁺, where the three-dimensional frameworks are obtained and [Zn₂(μ-OOC)₃] acts as connection node, the emission shifts to the blue light region at 470 nm. However, when it's in the Me₄N⁺ case, the framework uses both [Zn₂(μ-OOC)₂] and single Zn(II) as connection nodes in the structure. Because less (μ-OOC) is used in those Zn-nodes, the emission wavelength shifts toward the violet direction and gives an emission at 450 nm. When the three-dimensional frameworks contains both [Zn₂(μ-OOC)₂] and [Zn₄(O)(μ-OOC)₇] clusters as nodes, as in the case of MOF {Zn-BTC}{n-Bu₂NH₂⁺}-M2, the emission wavelength shifts to 515 nm, producing a green light.

Also, frameworks which have the same Zn-BTC anionic structure ho in FIG. 5 provided good examples for understanding how the differences in the inclusive cations influence on the fluorescence of the frameworks. The less interactions between the cations and anionic frameworks in the MOFs, the longer wavelength of emission the MOF's can have. For example, as listed in Table 1, for cations that can form additional hydrogen bonding with the frameworks, i.e., Me₂NH₂⁺, Et₃NH⁺, Et₂NH₂⁺, and n-Bu₂NH₂⁺, the pKa of the corresponding amines increases (pKa for Me₂NH=10.64, Et₃N=10.65, Et₂NH=10.98, and (n-Bu)₂NH=11.25)¹³), Thus, the strength of hydrogen bonding N—H . . . O can decrease in the same order. For the similar ammonium cations R₂NH₂⁺, from Me- to Et-, and further to Bu-substituted ones, the interaction between cations and framework becomes weaker in the same order. The emission changed from indigo light at 434 nm to 455 nm and finally to blue light at 476 nm, respectively. The BMIM and (PhCH₂)Me₃N⁺ cations cannot have hydrogen bonding with the frameworks. The imidazolium cation provides a green emission at 520 nm while (PhCH₂)Me₃N⁺ provides an indigo emission at 445 nm. This can result from the BMIM having a distributed positive charge along the imidazole ring, compared to the relatively localized charge in the (PhCH₂)Me₃N⁺ cation, which as a result influences the electrostatic interactions within the framework. Cations (PhCH₂)Me₃Kr can only have electrostatic interactions with the frameworks when compared with the secondary dialkylammonium cations that can have additional hydrogen bonding with the frameworks. However, the (PhCH₂)Me₃N⁺ cation provides a similar emission at 445 nm as the Me₂NH₂⁺ and Et₂NH₂⁺ cations, which shifted to the violet region direction unlike the (n-Bu)₂NH₂⁺ cations.

The changes of the emission wavelength in the MOFs may have a relationship with the width of the cross-section size of the channels (as shown in Table 1). The cations can act as electron withdrawing agents from the anionic Zn-BTC frameworks. The stronger the interactions, the lesser the number of electrons that may be distributed along the conjugated Zn-BTC framework and the greater the shift in the resulting emission to the shorter wavelength direction.

Although this applies to the anionic frameworks, it can also be applied to the two IM coordinated neutral frameworks. As shown in FIG. 9, MOF {Zn-BTC-IM} has a three-dimensional framework, and contains both [Zn₂(μ-OOC)₃] and [Zn₂(μ-OOC)₄] clusters as connection nodes, while MOF {Zn-BTC-2IM} has one-dimensional chain structures which are cross-linked through hydrogen bonding to form a framework, and contains the cluster [Zn₂(μ-OOC)₄] and single Zn(II) ions as the connection nodes. MOF {Zn-BTC-IM} could give a longer wavelength emission than MOF {Zn-BTC-2IM}. MOF {Zn-BTC-IM} provides a yellow emission at 543 nm and MOF {Zn-BTC-2IM} provides a blue emission at 470 nm. Overall longer emission wavelength of both Zn-BTC-IM frameworks can be expected as compared to the anionic Zn-BTC frameworks.

In summary, a series of anionic Zn-BTC frameworks with NH₄⁺ or organic cations residing in voids of the frameworks can be formed and corresponding fluorescence of the frameworks can be achieved. Cations acting as structure-directing agents affect the coordination structure of the Zn-BTC anionic frameworks. Most of the frameworks contain (μ-OOC) bridged Zn(II)-clusters as connecting nodes, such as [Zn₂(μ-OOC)₂], [Zn₂(μ-OOC)₃], [Zn₂(μ-OOC)₄], and [Zn₄(O)(μ-OOC)₇].

All of the Zn-BTC anionic frameworks described herein showed fluorescent emission in the visible spectrum region. The fluorescent emissions are closely related to the (μ-OOC) bridged Zn(II)-clusters. The more the Zn(II) and (μ-OOC) bridging BTC contributed into the cluster, the longer the observed emission wavelength. In the same iso-reticular Zn-BTC anionic frameworks, the strength of interactions between the inclusive cations and framework influences the emission as well. Lesser interactions result in the emission shifts to the longer wavelength direction.

Based on the foregoing, it can be appreciated that a number of embodiments, preferred and alternative, are disclosed herein. For example, in one embodiment, a metal-organic framework comprises a plurality of metallic ions; a plurality of organic linking anions that connect adjacent metallic ions of said plurality of metallic ions; and a plurality of cations connected to said plurality of organic linking anions, wherein said plurality of cations is selected from the group consisting of inorganic cations, organic cations, imidazolium based cations, pyridinium based cations, amino acids, cationic organic polymers, and coordinated ligands. The inorganic cations are selected from the group consisting of NH₄⁺ and Li⁺.

In another embodiment, the organic cations are selected from the group consisting of MeNH₃⁺, Me₂NH₂⁺, Et₃NH⁺, and n-Bu₄N⁺. The imidazolium based cations comprise 1-Butyl-3-methylimidazolium.

In yet another embodiment, the cationic organic polymers are selected from the group consisting of polyaniline emeraldine salt, polyquaterniums, and polypyrrole salt. Additionally, the coordinated ligands comprise imidazoles.

In another embodiment, a method of making a metal-organic framework comprises combining Zn(NO₃)₂.6H₂O, 1,3,5-benzenetricarboxylic acid, and a cation containing compound to create a solution; and heat treating said solution to create crystals. The method further comprises wherein said cation containing compound is selected from a group consisting of formamide, amine base, immonium salt, and 1-Butyl-3-Methyl-imidazolium Tetrafluoro-borate.

In another embodiment of the method, the formamide is selected from a group consisting of Formamide, N-Methylformamide, Dimethylformamide, Diethylformamide, and N,N-Dibutylformamide. Additionally, the amine base is selected from a group consisting of Dibutylamine, Triethylammine, and Imidazole.

In another embodiment, the immonium salt is selected from a group consisting of Tetramethyl-ammonium hydroxide pentahydrate, Tetrabutyl-ammonium nitrate, and Benzyltrimethyl-ammonium Chloride. The method further comprises adding alcohols comprising ethanol to said solution prior to heat treating. The method further comprises adding N-Methyl-2-pyrrolidone to said solution prior to heat treating. The method can further comprise washing said crystals. The method can further comprise adding/doping at least one metallic ion to said solution prior to heat treating said solution.

It will be appreciated that variations of the above-disclosed and other features and functions, or alternatives thereof, may be desirably combined into many other different systems or applications. Also, that various presently unforeseen or unanticipated alternatives, modifications, variations or improvements therein may be subsequently made by those skilled in the art which are also intended to be encompassed by the following claims.

What is claimed is:

1. A metal-organic framework comprising:
a plurality of metallic ions;
a plurality of organic linking anions that connect adjacent metallic ions of said plurality of metallic ions; and
a plurality of cations connected to said plurality of organic linking anions, wherein said plurality of cations is selected from the group consisting of inorganic cations, organic cations, imidazolium based cations, pyridinium based cations, amino acids, cationic organic polymers, and coordinated ligands.

2. The metal-organic framework of claim wherein said inorganic cations are selected from the group consisting of NH₄⁺ and Li⁺.

3. The metal-organic framework wherein of claim 1 said organic cations are selected from the group consisting of MeNH₃⁺, Me₂NH₂⁺; Et₃NH⁺, and n-Bu₄N⁺.

4. The metal-organic framework of claim 1 wherein said imidazolium based cations comprise 1-Butyl-3-methylimidazolium.

5. The metal-organic framework of claim 1 wherein said cationic organic polymers are selected from the group consisting of polyaniline emeraldine salt, polyquaterniums, and polypyrrole salt.

6. The metal-organic framework of claim 1 wherein said coordinated ligands comprise imidazoles.

7. A method of making a metal-organic framework comprising:
combining Zn(NO₃)₂. 6H₂O, 1,3,5-benzenetricarboxylic acid, and a cation containing compound to create a solution; and
heat treating said solution to create crystals.

8. The method of claim 7 wherein said cation containing compound is selected from a group consisting of formamide, amine base, immonium salt, and 1-Butyl-3-Methyl-imidazolium Tetrafluoro-borate.

9. The method of claim 8 wherein said formamide is selected from a group consisting of Formamide, N-Methylformamide, Dimethylformamide, Diethylformamide, and N,N-Dibutylformamide.

10. The method of claim 8 wherein said amine base is selected from a group consisting of Dibutylamine, Triethylammine, and Imidazole.

11. The method of claim 8 wherein said immonium salt is selected from a group consisting of Tetramethyl-ammonium hydroxide pentahydrate, Tetrabutyl-ammonium nitrate, and Benzyltrimethyl-ammonium Chloride.

12. The method of claim 7 further comprising adding alcohols comprising ethanol to said solution prior to heat treating.

13. The method of claim 7 further comprising adding N-Methyl-2-pyrrolidone to said solution prior to heat treating.

14. The method of claim 7 further comprising washing said crystals.

15. The method of claim 7 further comprising adding/doping at least one metallic ion to said solution prior to heat treating said solution.
